(19) United States
(12) Patent Application Publication
(10) Pub. No.: US 2004/0115359 A1
(43) Pub. Date: Jun. 17, 2004

(54) Method for controlling a surface coating installation

(76) Inventors: Dominique Cebola, Coublevie (FR); Lionel Charpin, Meylan (FR)

Correspondence Address: CANTOR COLBURN, LLP, 55 GRIFFIN ROAD SOUTH, BLOOMFIELD, CT, 06002

(21) Appl. No.: 10/451,053

(22) PCT Filed: Dec. 18, 2001
(86) PCT No.: PCT/FR01/04045

(30) Foreign Application Priority Data
Dec. 19, 2000 (FR) 00 16608

(51) Int. Cl. B05D 1/02

(52) U.S. Cl. 427/421

(57) ABSTRACT

The invention concerns a method for controlling a surface coating installation comprising at least a multi-axial machine (3, 4, 5), each axis being equipped with motoring means, and the machine being provided with equipment such as a sprayer (8) and corresponding sensors and actuators. Said method consists in characterising the jets of treatment product, for each of the types of equipment, and in storing said data; in characterising the machines (3, 4, 5), more particularly their kinematic axes; in recording the characteristics of a component (2) to be treated; in automatically creating, on the basis of said elements, the trajectories of the machines taking into account the desired thickness of the treatment product. Said method enables the automatic generation of application files for painting motor vehicle bodies.

The present invention relates to a method of controlling a surface coating plant, especially for the automobile industry. This method is applicable, in particular, to controlling an automatic plant for painting automobile bodywork, by means of machines equipped with paint sprays.

In the automobile industry, a surface treatment plant, intended for example for painting bodywork carried and moved by a conveyer, comprises for example a set of six machines for coating the side walls of the bodywork and one machine also called a “roof machine” for coating surfaces of this bodywork which are substantially horizontal. Each of the six machines referred to as side machines is equipped with a spray, while the roof machine comprises three separate sprays. Such a plant operates synchronously with the conveyer, moving the bodywork to be painted forward. It further comprises a cabin provided with vertical ventilation and a system for recovering the coating product.

The device for controlling such a plant in particular makes it possible:

to identify the type of bodywork entering the plant region and monitoring this bodywork until it leaves the region;

to provide the movement kinematics of each of the machines and to control the spray parameters of the spray or sprays that it supports; on each occasion, the movement kinematics and the spray parameters are specific to the bodywork being treated.

Such control systems are described in French patent application No. 00.04074 filed on Mar. 30, 2000 in the name of the applicant, and published under No. 2806934.

One of the “intelligent” components of the control system places, for each type of bodywork, a table called an “application file” in memory, which table contains all the positioning commands for each of the machines and other elements together with the setting for each of the sprays depending on the progression of the bodywork on the conveyer. At regular intervals, each interval corresponding, for example, to the movement of the bodywork on the conveyer over a predetermined distance, the machines and sprays require new settings since the bodywork has moved forward within the plant.

The application files for each type of bodywork are programmed on a computer running the program. Producing these files consists, for bodywork having a given shape, in entering, for various positions of the bodywork in the plant, the various commands corresponding, for example, to the positions of the various axes of each machine, to the flow rate of treatment product for each of the sprays, to the electrical voltage applied (for an electrostatic spray), etc.

The time needed to optimize the application files for each item of bodywork is very high. It is in fact necessary to record a large number of points so that the kinematic envelope of each of the machines is close to the shape of the bodywork item. This is true for each bodywork item and generally there are on average twenty bodywork items for each production factory. As a result, the number of points for the application files is limited to about a hundred, depending on the complexity of the external shape of the bodywork item. Furthermore, given the various types of paint, adjustments of the spray settings are necessary, depending on the shades. As a result, the number of application files is further multiplied by the number of shades, so that, in total, tables comprising some ten thousand programming points are obtained.

Furthermore, it is necessary to test these application files to actual size, that is to say on a bodywork item. Such a testing and adjustment phase may last from a few days to several weeks. It is expensive in terms of time and also in operating costs, insofar as it consumes the coating and cleaning product and insofar as it makes the plant dirty and therefore requires maintenance. Furthermore, in automobile factories, it is common to replace old plants with new plant during the summer period of production shutdown. There are then four weeks during which it is necessary to dismantle the old plant, modify the infrastructures, assemble the new plant, carry out commissioning and empty testing and finally to adjust the application so as to be ready to start up in full production with the minimum of waste. The testing and adjustment phase represents the longest and most uncertain part of starting up a new plant.

The test phase also represents a significant operational cost since it is necessary to use bodywork items, paint and cleaning product. It is also necessary to make the whole plant function, namely the product distribution network, compressed air network, conveyer, cabin, furnace. It is also necessary to clean the machines and the cabin after each test period.

The present invention seeks to avoid all these drawbacks, and therefore it has the aim of providing a method making it possible to reduce the costs of the phases for testing and optimizing the application files, by decreasing the time needed for these phases and/or the operational costs associated therewith, this method also advantageously making it possible to introduce modifications more easily when a new type of bodywork or, more generally, of part to be treated appears, or when characteristics of the sprayed product change.

To this end, the subject of the invention is mainly a method of controlling a surface coating plant, especially for the automobile industry, more particularly for a surface coating plant comprising at least one multiaxis machine, each axis being equipped with motor means, the or each machine being provided with equipment such as, for example, a spray together with corresponding sensors and actuators, this method consisting:

in characterizing the jets of treatment product, such as paint, for each of the equipment types such as spray and for each of the treatment product types, such as paint, and in storing these elements in a spray database,

in characterizing the machine or machines for applying treatment product, such as paint, and more particularly the kinematic axes of each machine, on joining these axes together,

in recording the characteristics of a part such as bodywork to be surface treated, and

in automatically creating, from all the preceding elements, and from the thickness of treatment product desired at every point of the part to be treated, the courses of each machine for applying treatment product, such as paint.

For a plant comprising a plurality of machines, the method may further comprise a step of automatically allocating tasks to the various machines of the plant, and breaking down the surface to be treated, such as bodywork, into regions treated respectively by these various machines.

Advantageously, the method further comprises a step of automatically generating the settings of the equipment, such as a spray, at each point of the course of the corresponding machine, especially as a function of the desired thickness of treatment product, such as paint, to be sprayed.

With respect to the foregoing, the method of the invention may also comprise a step of simulating the thicknesses of treatment products, such as paint, obtained, advantageously supplemented by a step of displaying the thicknesses of treatment product obtained at the end of simulation.

Thus, in the assembly, the method which is the subject of the invention allows, in some way, the automatic writing of application files, avoiding the lengthy and expensive tests, by simulating the movement of each machine and the operation of its equipment such as a spray, while at the same time allowing the results obtained to be verified and validated, possibly after manual or automatic correction of the thickness of treatment product, for example at certain particular points, which pose a problem.

In detail, the method of the invention, used (by way of example) for painting bodywork, by means of machines equipped with sprays, firstly consists in characterizing the paint jets for each of the spray types and for each of the paint types. These tests are carried out in the laboratory on the plates, at different flow rate values, at different values of shaping air, at different values of high electrical voltage, at different distances and at the nominal speed of the conveyer, and make it possible to measure the impact of the paint jets (shape, especially width and height) and the thicknesses of paint obtained. These data are then stored in a database, with the properties of the paint (viscosity, solids content percentage, etc.).

Secondly, it is necessary to characterize the application machine or machines. Thus, each kinematic axis (acceleration, speed, travel, etc.) is entered into a computer in the form of an equation. The axes are then “joined” for example by circular interpolation. This means that an operator does not have to program each of the axes but just give the position in which the spray nozzle has to be. The computer will then determine, from the previous position, the setpoints to be applied to the variable speed drives, corresponding to each axis while complying with the kinematic limits of the machines.

Next, the bodywork is introduced into the computer in the form of a “3D” digital file, for example by means of a CD-ROM, directly transmitted by the final manufacturer. On the basis of this file, the method consists in creating the kinematic envelope of all of the machines by means of a certain number of rules, such as the following:

Each “plane” constituted by a pair of machines, substantially situated face to face on each side of the cabin and working symmetrically, is allocated to a region of the vehicle to be painted; for example, one plane looks after the horizontal regions of the front hood, the roof and the trunk, another plane takes care of the lower shell going down to the wheel housing and the third plane looks after the intermediate region.

Regions representing large areas are painted by describing oscillations making it possible to simulate the strips of paint having the width of a jet; to coat all these regions properly, the strips must overlap and must do so in the same way over the entire region so as to preserve a constant thickness. Thus, the period of the oscillation multiplied by the speed of the conveyer must be of the order of a half-impact width, or even a third.

In order to have the correct rate of movement of the machine when opening the paint jet, it is necessary to provide overtravel during which the machine will slow down or accelerate.

The load rate for each of the machines must be as similar as possible from one machine to another; it is not a question for example of having one “plane” operating for 80% of the time and another for 20%.

The movements described without spraying paint are minimized and a ratio of the area covered by each machine to its painted surface is given at the end of simulation.

Allocating the tasks to the various “planes” and breaking down bodywork into regions can be carried out manually or automatically.

At the end of this step, the method makes it possible to completely simulate the movements of each of the machines around the bodywork and to display these kinematics on a screen. It is possible optionally to generate an error file in which the regions or positions posing a problem are given (overspeed of one axis, exceeding a limit of one axis, inaccessible point). Manual connections may be given to the kinematics, for example in order to correct a point.

It then remains, from this course and the desired paint thicknesses for each of the bodywork regions, to determine the settings for each of the spray parameters at every point. This operation is carried out automatically, from the database constructed, by means of tests carried out in the laboratory on the planes and which make it possible at every point of the course to allocate a paint jet and therefore the settings of each of the sprays in order to obtain the desired paint thickness. Efficiency of the application coating, that is to say the ratio of the amount of paint actually applied to the bodywork to the amount of paint sprayed, depending in particular on the type of spray used (with or without an electrostatic effect), is also applied so as to come as close as possible to reality. At the end of this step, it is possible to display on a screen the theoretical thickness obtained at every point of the bodywork and possibly the differences compared to the desired thickness.

Thus the method makes it possible to automatically generate application files for each bodywork item and for each shade. These files are then tested to actual scale at the premises of the final user on the bodywork items. Paint thickness readings are taken and, at the over-thickness and under-thickness regions, due especially to the particular topology of the regions and to the actual spray conditions, manual or automatic corrections making it possible to obtain the correct paint thicknesses may be made to the application files.

The errors generated during the kinematic simulation phases or painting, and the corresponding corrections, may supply a database which will make it possible, by means of an expert system, to correct them automatically at the first simulation.

The method which is the subject of the invention is illustrated, within the context of a particular application, by the appended schematic drawing, in which:

FIG. 1 is a top plane view of a portion of a bodywork painting plant, controlled using the method of the present invention;

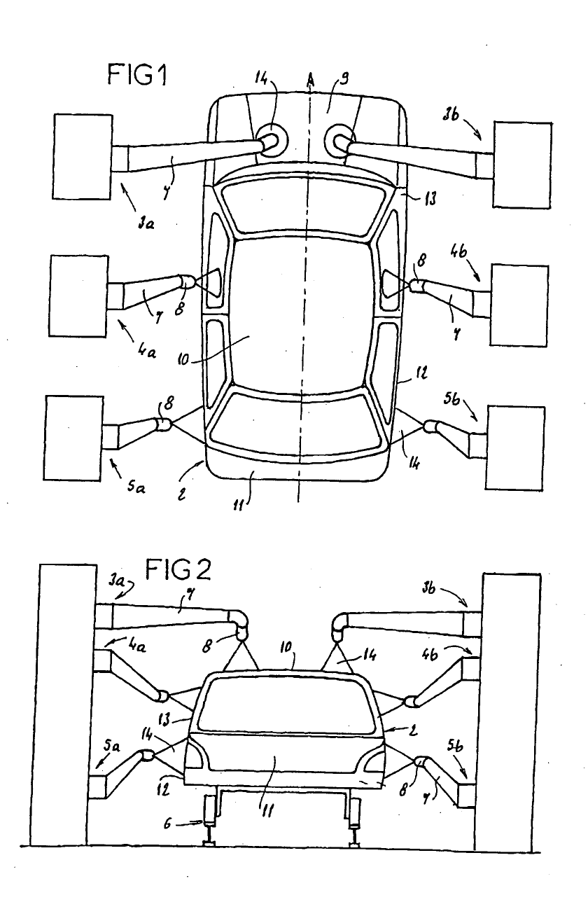

FIG. 2 is an end view of the paint plant of FIG. 2;

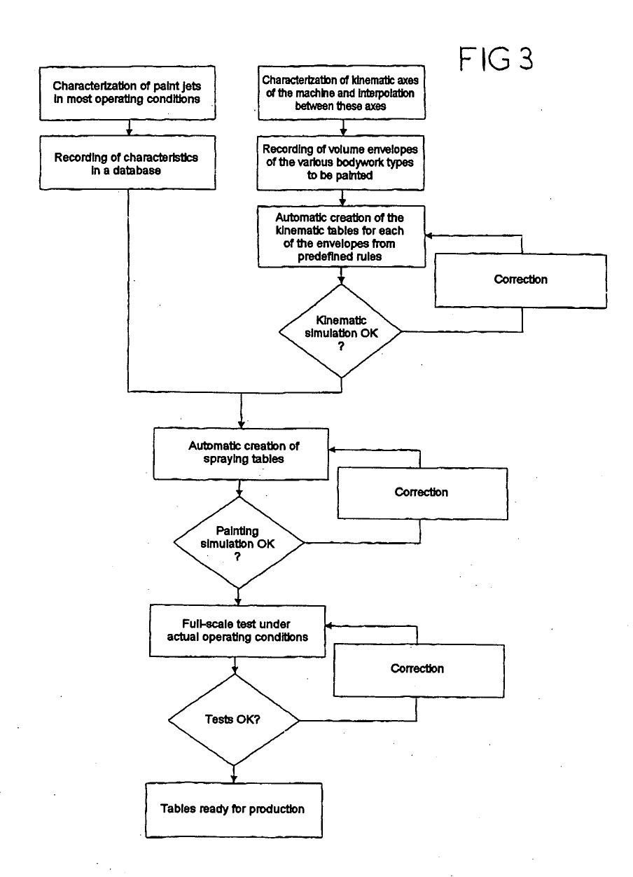

FIG. 3 is a flow chart showing the steps of the method according to the invention, applied to this type of plant.

As illustrated in FIGS. 1 and 2, the method, subject of the invention, is especially applicable to controlling a plant for painting bodywork 2 of automobiles. The plant is of the type comprising multiaxis side machines 3a, 3b, 4a, 4b, 5a, 5b placed on each side of a conveyer 6 moving the bodywork items 2 to be painted forward, which follow each other with a certain spacing. Where required, this plant also comprises a machine called a “roof machine” (not shown) placed above the conveyer 6.

The two side machines 3a, 3b are placed face to face. This is the same for the second pair of machines 4a, 4b, and for the third pair of machines 5a, 5b.

Each of these machines 3a, 3b, 4a, 4b, 5a, 5b comprises a frame supporting a robotic moveable arm 7, which carries at its end a spray 8 combined with a paint reservoir. Two machines located facing each other form what is called a “plane”, and are allocated to painting defined regions of a bodywork item 2. For example:

the plane constituted by the first pair of machines 3a, 3b paints the front hood 9, the roof and the trunk 11 of the bodywork 2;

the plane constituted by the third pair of machines 5a, 5b paints the lower shell 12 of the bodywork 2;

the plane constituted by the second pair of machines 4a, 4b paints the intermediate region 13 of the bodywork 2 (producing the junction between the “high” and “low” regions previously defined).

The method, subject of the invention, automatically prepares the work of the various machines 3a, 3b, 4a, 4b, 5a, 5b, as a function of the bodywork 2 involved, of the characteristics of the kinematic axes of the machines 3a, 3b, 4a, 4b, 5a, 5b, and the characteristics of the sprays 8 therefore of their paint jets 14. This method makes it possible to generate and validate the “application files”, with tests and corrections, so as to define and control, taking into account the thickness of paint desired:

the courses and speeds of the machines 3a, 3b, 4a, 4b, 5a, 5b;

the settings of the respective sprays 8 of each of these machines;

if required, the allocation of the tasks (breakdown of the bodywork 2 into regions) to the various “planes” of machines 3a, 3b or 4a, 4b or 5a, 5b, respectively.

The steps of the method are illustrated by the flowchart of FIG. 3, with reference to the particular application of the invention to painting bodywork, previously described with reference to FIGS. 1 and 2.

The method, subject of the invention, may be applied to any system for controlling an automatic surface coating plant by gun or similar technique, whatever the parts to be treated, and whatever the number and the particular features of the machines used.

1. A method of controlling a surface coating plant comprising at least one multiaxis machine (3, 4, 5), each axis being equipped with motor means, the or each machine being provided with equipment such as, for example, a spray (8) together with corresponding sensors and actuators, the method consisting:
in characterizing the jets of treatment product, such as paint, for each of the equipment types such as spray and for each of the treatment product types, such as paint, and in storing these elements in a spray database,
in characterizing the machine or machines (3, 4, 5) for applying treatment product, such as paint, and more particularly the kinematic axes of each machine, on joining these axes together,
in recording the characteristics of a part (2) such as bodywork to be surface treated, and
in automatically creating, from all the preceding elements, and from the thickness of treatment product desired at every point of the part (2) to be treated, the courses of each machine (3, 4, 5) for applying treatment product, such as paint.

2. The method as claimed in claim 1, characterized in that, for a plant comprising a plurality of machines (3, 4, 5) for applying treatment product, the method further comprises a step of automatically allocating tasks to the various machines (3, 4, 5) of the plant, and breaking down the surface to be treated, such as bodywork (2), into regions (9 to 13) treated respectively by these various machines.

3. The method as claimed in claim 1 or 2, characterized in that it further comprises a step of automatically generating the settings of the equipment, such as a spray, at each point of the course of the corresponding machine (3, 4, 5), especially as a function of the desired thickness of treatment product, such as paint, to be sprayed.

4. The method as claimed in claim 3, characterized in that it also comprises a step of simulating the thicknesses of treatment product, such as paint, obtained.

5. The method as claimed in claim 4, characterized in that said step of simulating thicknesses is supplemented by a step of displaying the thicknesses of treatment product obtained at the end of simulation.

6. The method as claimed in claim 5, characterized in that it further comprises a step of manually correcting the thickness of treatment product, especially at particular points.

7. The method as claimed in claim 5, characterized in that it further comprises a step of automatically correcting the thicknesses, from thickness readings of the treatment product, especially at particular points.

8. The method as claimed in any one of claims 1 to 7, characterized in that it is applied to controlling a plant for painting bodywork (2)*of automobiles, the plant being of the type comprising multiaxis machines (3, 4, 5) placed on each side of a conveyer (6) moving the bodywork items (2) to be painted forward, and if required a machine placed above this conveyer, each machine (3, 4, 5) being equipped with at least one spray (8), the method automatically generating “application files” for such a plant.
